(19) United States
(12) Patent Application Publication
(10) Pub. No.: US 2016/0328781 A1
(43) Pub. Date: Nov. 10, 2016

(54) DELAYED ORDER DELIVERY FULFILLMENT

(71) Applicant: BBY SOLUTIONS, INC, Richfield, MN (US)

(72) Inventors: Sanu Patel-Zellinger, Minneapolis, MN (US); Julie Durham, Minneapolis, MN (US); Brian Flynn, Minneapolis, MN (US); Ryan Mendoza, Minneapolis, MN (US); Rick Patterson, Minneapolis, MN (US); Rob VanHout, Minneapolis, MN (US); Stephen Jakala, Minneapolis, MN (US); Charles Rooney, Minneapolis, MN (US); Vikas Jaiswal, Minneapolis, MN (US); Magesh Venkatesan, Minneapolis, MN (US); Raghu Venkateshwar, Minneapolis, MN (US); Asad Khan, Minneapolis, MN (US); Puneet Gupta, Minneapolis, MN (US); Vaibhav Agrawal, Minneapolis, MN (US); Eric Berens, New York, NY (US); Curtis Janicke, Minneapolis, MN (US)

(21) Appl. No.: 14/704,776

(22) Filed: May 5, 2015

(51) Int. Cl. G06Q 30/06; G06Q 10/08

(52) U.S. Cl. CPC G06Q 30/0635; G06Q 10/087; G06Q 10/0835

(57) ABSTRACT

Techniques and system configurations for order tracking and delivery fulfillment in an electronic commerce setting is described herein. In one example, a shipment that originates from a distribution center of a retailer is identified for delay (e.g., a delayed shipment in transit via a national carrier). The delayed shipment is replaced with a substitute shipment from inventory at an in-store location of the retailer. The substitute shipment is selected from an in-store location of the retailer based on proximity to the shipping destination, and is delivered via courier or agent to meet or precede a promised delivery date. The delayed shipment is then intercepted or redirected to the shipping source, the in-store location, or a distribution center. Related techniques for the management, processing, and tracking of data and information associated with substitute shipments are further described herein.

### TECHNICAL FIELD

Embodiments pertain to order fulfillment, logistics, and delivery techniques for items of commerce. Some embodiments pertain to techniques to track, manage, and modify electronic data and information related to orders for items of commerce, to ensure that delivery of the items of commerce can be delivered on or before special events, holidays, and like target delivery dates.

### BACKGROUND

Many retailers and distributors of goods (including online and phone-based retailers and distributors) increasingly rely on shipping services to deliver goods to customers' homes and businesses. Sellers of goods are particularly reliant on third party shipping services for the “last mile” delivery to the consumer's home or business delivery location. Even if the shipment of the goods is placed into transit on-time, various delays may occur in the distribution network that can prevent a timely delivery. For example, such delays could occur as a result of adverse weather conditions, delivery network interruptions, or other factors out of the seller's control.

Customers increasingly want more information and control over their delivery options, especially when making gift-based orders in advance of birthdays, holidays, or other pre-determined delivery dates. Various processes exist to allow sellers to track the status of deliveries, and to allow the seller to determine whether certain deliveries are likely to be delayed or unable to meet a pre-determined delivery date. However, existing tracking processes are typically limited to collecting information about the delayed delivery and providing only a status update or apology to affected customers. Such information is unlikely to satisfy an expectant customer if the order is unable to be fulfilled prior to the holiday or previously promised delivery date. Thus, if a delivery delay or cancellation occurs, the seller may be blamed for the failure (even if the reason for the delay is outside of the seller's control).

### BRIEF DESCRIPTION OF THE DRAWINGS

FIG. 1 illustrates an overview of shipment interception and substitution according to an example described herein.

FIG. 2 illustrates an overview of an order delivery workflow according to an example described herein.

FIG. 3 illustrates an example processing flowchart of a delayed order replacement workflow according to an example described herein.

FIG. 4 illustrates an example data flow diagram for a delayed order replacement workflow according to an example described herein.

FIG. 5 illustrates an example scenario of retailer processing for a delayed order replacement workflow according to an example described herein.

FIG. 6 illustrates an example scenario of delivery processing system actions for a delayed order replacement workflow according to an example described herein.

FIG. 7 illustrates an example scenario of resolution contact procedures for a delayed order replacement workflow according to an example described herein.

FIG. 8 illustrates an example block diagram of processing components for implementation of a delayed order replacement workflow according to an example described herein.

FIG. 9 illustrates an example method for processing data in a delayed order replacement workflow according to an example described herein.

FIG. 10 illustrates an example method for generating shipment interception and substitution data transactions in a delayed order replacement workflow according to an example described herein.

FIG. 11 is a block diagram illustrating operational components of a computing device upon which any one or more of the methodologies herein discussed may be run.

### DETAILED DESCRIPTION

The following description and drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

Some of the examples detailed herein are directed to techniques that enable tracking and identification of delayed orders and shipments in connection with product management workflows and related data management actions. As discussed herein, store and omnichannel retail fulfillment techniques may be used for ensuring customer delivery of problematic orders and shipments before special events, holidays, or promised delivery days. For example, the techniques discussed herein can operate to: identify delayed or high-risk-of-delay shipments; identify products from local stores or distribution centers to fulfill the orders; generate notification and fulfillment requests to local brick-and-mortar stores or distribution centers; coordinate courier or store-based delivery of the products from local stores or distribution centers; and intercept/redirect any delayed packages in transit once the local delivery has been made.

As further discussed herein, the deployment of in-store resources may be used to automatically locate, generate, and fulfill in-progress or in-transit orders and shipments that are projected as unlikely or unable to arrive before a promised or preferred time. In scenarios where shipping resources, third parties, or internal processes prevent the retailer from meeting a promised delivery date, resources from a suitable store location or local distribution center may be re-deployed to fulfill the order. With use of these delayed order detection and shipment re-deployment techniques, a retailer can attempt to achieve a complete fulfillment of customer orders by meeting its promised delivery date. This has the logical benefit of providing a consistent and positive experience for customers, and enhanced customer satisfaction for the shipment process.

With the examples provided herein, technical enhancements can be implemented within a fully integrated, sustainable from-store delivery capability that is seamless and simple to execute against. The use of the workflow management techniques can be used to assist the delivery of products when, where and how the respective customers want to receive them—consistently and reliably on time. Further, the use of the techniques and workflows described herein can enable shipping and convenience benefits for a variety of types of deliveries, while reducing costs and improving customer experiences. In addition to such business-related benefits, the presently described techniques and workflows may be integrated into existing retailer information systems and computerized processing networks to enable improved processing and data management of orders and shipments. As further detailed herein, technical implementations of the present techniques may include the improved storage, access, and management of data; the improved operation of databases that track orders, shipments, and inventory; and improved uses of data to manage and automate delivery processes.

The following examples illustrate various enhancements that can be applied to allow a distribution and ship-from-store network to provide greater speed and delivery options for customers. As discussed herein, the enhancements to a retailer's operations and systems can be used to implement guaranteed shipping options, through: expanding the days and times of distribution operations; tracking and coordinating data maintained in order management and e-commerce product management systems; and expanding the diversification of transportation carriers to enhance speed and choice of delivery options. Further, the enhancements may include the integration of an in-store shipping tool that will allow for the systematic upgrade or downgrade of a particular order's “shipping speed” in order to optimize cost and meet any customer requested or promised “in-hand” date.

As described herein, the various techniques for delayed order and delayed shipment fulfillment may be provided through the use of a fully integrated, sustainable from-store delivery capability that is seamless and simple to execute against. In some examples, the delayed order and delayed shipment fulfillment may be implemented as a simple contingency plan with minor automation and manual intervention to close gaps in coverage; in another example, the delayed order and delayed shipment fulfillment may be implemented as a comprehensive automated model. As also described herein, these fulfillment techniques may build around existing retail processes and systems, with improvements to existing shipment processes being used to keep customer experiences positive and consistent. Similarly, these fulfillment techniques may integrate with new data processes and system upgrades, to enable long-term cost effectiveness, and to enable retail tracking and location-based tracking of sales (for example, to allow a particular retail location to obtain credit for any sales that the location is responsible for fulfilling).

As a result of the techniques described herein, a retailer can significantly reduce the number of delayed orders and shipments that would otherwise not be delivered on time (towards a goal of 100 percent of orders delivered on time). As a result, such delivery improvements will have the effect of increasing a retailer's Net Promoter Score (NPS), and other measurements of customer satisfaction. Further, the techniques described herein may be used in connection with advanced analytics and coordination for order and shipment creation, sourcing, and delivery, through appropriate management, synchronization, coordination, and tracking of data for orders, shipments, inventory levels, purchase transactions, and related corporate purchase and fulfillment operations.

As used in the following examples, the term “order” generally refers to an electronically-tracked (and, potentially electronically-originating) request for fulfillment of a purchase for a particular set of one or more goods. This request may originate from a consumer purchase from an electronic point of sale system, an electronic commerce website, or from other systems operated by a retailer. As also used in the following examples, the term “shipment” refers to an electronically-tracked instance of transit, used to fulfill the delivery of the order, that includes all or a portion of the particular set of the one or more goods. This instance of transit may be initiated by the retailer, by a third party fulfillment provider, by a distributor or manufacturer, or by other entities on behalf of the retailer. The movement of this instance of transit may be performed by a common carrier, a contract or private carrier, or by entities associated with or under contract with the retailer, distributor, or manufacturer.

It will be understood that in some of the following scenarios, the terms “order” and “shipment” may be used interchangeably. For example, when a package is in transit, the status of the order (e.g., being delayed due to shipping issues) will naturally correspond to the status of the shipment (e.g., being delayed due to weather issues in the shipping distribution network). However, it will be understood that the techniques described herein are not only applicable to the identification of a potentially delayed shipment, but also a potentially delayed order, and including in some scenarios, before goods associated with the order are prepared for shipment.

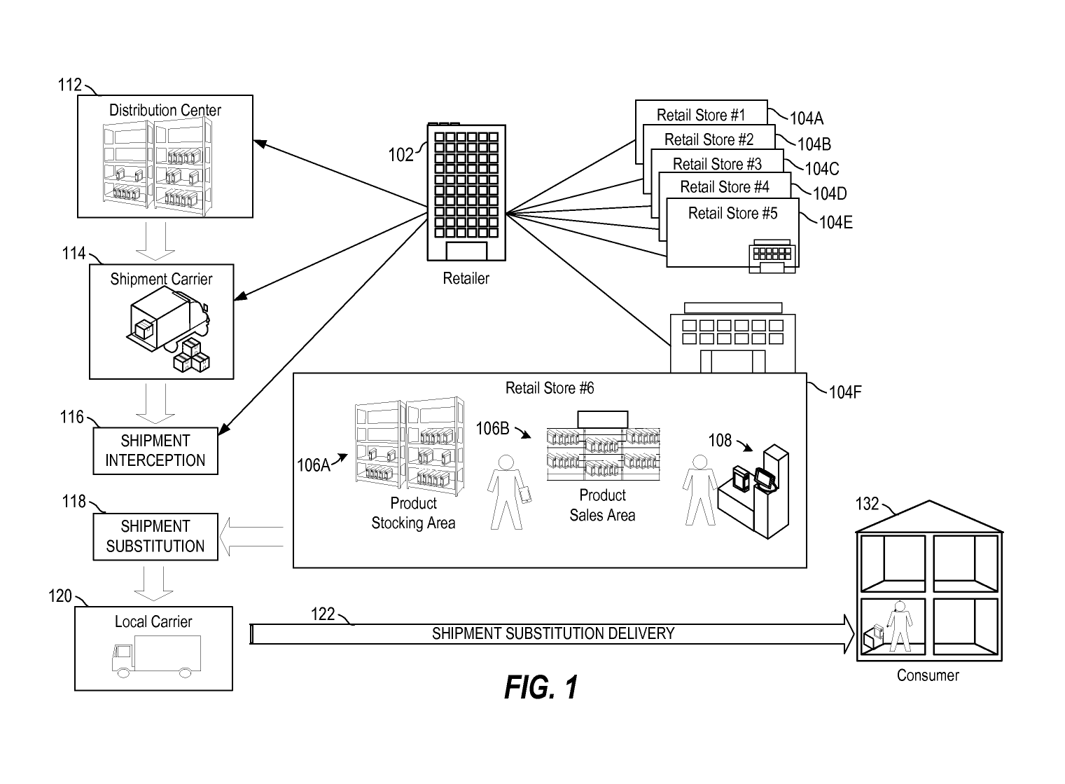

FIG. 1 provides an overview of the entities involved in connection with shipment interception and substitution operations according to various examples in the present disclosure. A retailer 102 may provide the sale and distribution of goods through various retail stores 104A, 104B, 104C, 104D, 104E, 104F, an electronic commerce (e-commerce) portal (not shown), and a distribution center 112. For example, an e-commerce order may occur in connection with the placement of a customer order through the website, mobile app, or other shopping portal for retailer 102. This e-commerce order may be followed by an attempted fulfillment of the order through a shipment sent from the distribution center 112 for delivery to the consumer 132 (such as with a scheduled delivery to the consumer's home or work place). In other examples, the e-commerce order may take place in connection with the fulfillment of a ship-from-store order, such as an order fulfilled from a particular retail store such as retail store 104A, or from a third party manufacturer or distributor (not shown).

The attempted fulfillment of the shipment for the e-commerce order through distribution center 112 involves the transit of the first set of goods through a shipment carrier 114. However, as previously discussed, various scenarios may occur where the shipment is delayed in transit and is unable to meet an estimated or promised delivery date or time. In such scenarios, the retailer 102 or another suited third party may intervene to provide a substitute shipment.

As shown in FIG. 1, the e-commerce order may be fulfilled from a retail store 104F, through use of a shipment substitution 118. The shipment substitution 118 may include goods that are obtained from an in-store product stocking area 106A (e.g., in a local store inventory), a product sales area 106B (e.g., on a sales floor), or at other locations in the retail store 104F. The shipment substitution 118 can then be provided to a local carrier 120, for a delivery 122 to the premises of the consumer 132, for example (or for delivery to other suitable locations such as a gift destination or an alternate delivery destination).

After recognizing that the consumer 132 has received his or her requested product, the delayed shipment or order may be stopped or redirected to prevent duplicate delivery of the subject goods to the consumer 132. For example, after the shipment substitution 118 is established or initiated for the replacement delivery (or after the delivery 122 of the shipment substitution is complete and the goods are provided to the consumer 132), the original shipment occurring via shipment carrier 114 may be halted or redirected through a shipment interception 116. The shipment interception 116 may operate to redirect the original package via the shipment carrier 114 back to the original distribution center 112, to another regional distribution center, or to a retail store such as the retail store 104F.

Accordingly, in a workflow that manages and implements the shipment substitution 118 and the shipment interception 116, the retailer 102 can operate various data-driven procedures to identify (and respond to) an at-risk order or shipment fulfillment. For example, commerce operations may occur at a data terminal 108 or other control station of the retail store 104F to process the creation and handling of order fulfillment from the inventory of the retail store 104F. These data-driven commerce operations may include order replacement identification, inventory management, courier management, and the like.

As further discussed herein, various techniques may be used by a retailer or an appropriate third party to identify, capture, and respond to an at-risk order or shipment. In one example, two categories may be established for at-risk orders and their associated shipments: a “RED” order, and a “YELLOW” order. RED orders may include those orders or shipments which are determined to be (or at a significantly high risk of being) late for a targeted delivery date (e.g., a customer-promised delivery date prior to a holiday). YELLOW flagged orders may include those orders or shipments which are at some risk of being late for the targeted delivery date, or are missing information to determine the proper delivery or transit status. YELLOW flagged orders can be identified and handled by an order management team (or other appropriate functional team or process of the retailer) to prevent the order from becoming RED. In contrast, an order or shipment that is at low-risk of being delayed can be identified as a “GREEN” order. Other statuses and categorizations may also be defined.

The characteristics for an order may be based on one or more factors affecting the current calculation of an “in-hand” date, generally defined as the estimated date for delivery to the consumer. For example, an originally projected in-hand date may be a projected or promised delivery date or time window that is estimated for the consumer, based on calculations performed at the time of sale or order fulfillment, which are performed at the retail store or provided via an e-commerce website (or provided via related customer notifications). The considerations for identifying a RED order may include factors such as: 1) the originally projected in-hand date is in the past and the item is not delivered; 2) the current time is past the last carrier pick-up time, the originally projected in-hand date is tomorrow, and the package is not yet in shipped status; 3) if the originally projected in-hand date is today, and the package is not yet in shipped status; 4) If the originally projected in-hand date is today, and the package is in shipped status, but there is no carrier origin scan; 5) if the current carrier estimated time to arrive (ETA) is later than the originally projected in-hand date.

Some of the considerations for identifying a YELLOW order may include factors such as: 1) the order is not in a shipped status, and today's date plus remaining ground time in transit is greater than the customer projected in-hand date; 2) the order is in a shipped status in a warehouse management system, but not in a shipped status in an order management system (in this case the customer may not receive a shipment notification); 3) orders that were shipped prior to the current date and do not have a origin carrier scan, and the in-hand date is greater than today; 4) orders that are not in a released status yet and after a processing deadline (such as 4 pm), and the in-hand date is tomorrow. The YELLOW order identification, however, may: 5) exclude shipments set to be shipped via national one-day shipping if the customer projected in-hand date is tomorrow; 6) exclude shipments set to be shipped via national two-day shipping if the customer projected in-hand date is two days out; and like criterion.

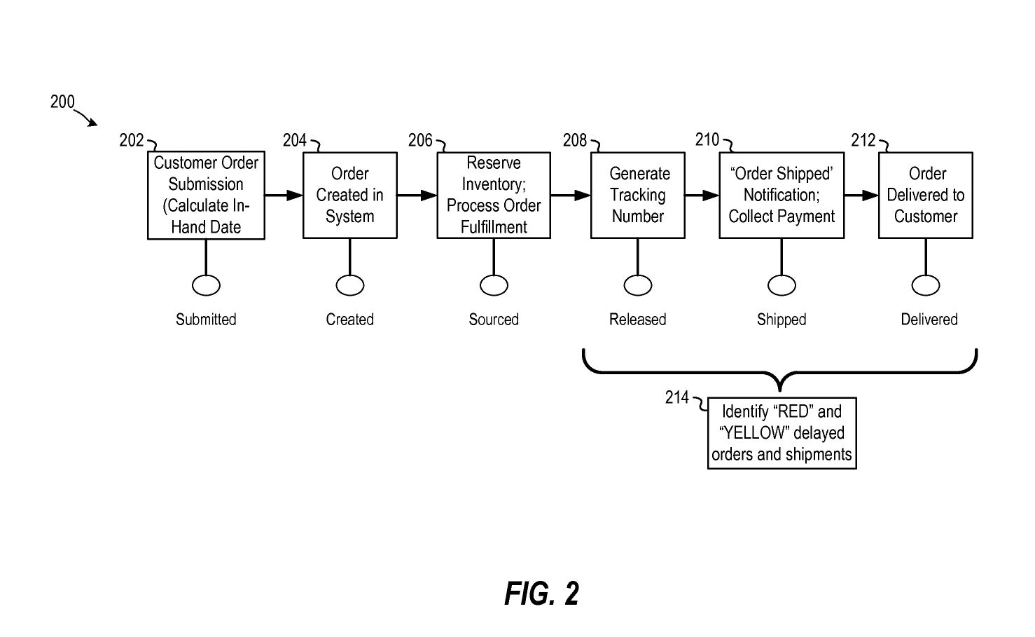

FIG. 2 provides an overview of an order delivery workflow 200 occurring within a distribution channel according to a further example, with the order delivery workflow 200 configured to identify YELLOW and RED orders at risk for delay or non-fulfillment. As shown, the workflow 200 includes the order being initially submitted with an electronic customer order submission 202. The electronic customer order submission 202 may be accompanied by operations such as the customer (or an agent assisting the customer) selecting the appropriate product SKUs and shipping options.

At the time of order submission, the originally projected in-hand date may be calculated and determined for the order. For example, this projected in-hand date may be provided to the customer as part of a selectable display of shipping options, as part of an electronic confirmation of the order (e.g., in a webpage or email confirmation). In these and similar examples, the projected in-hand delivery information may be provided at or adjacent to the time of purchase or initial shipping operations.

The workflow 200 further includes the order being created in an order management system (such as the retailer's order management system), with an electronic order creation operation 204. The workflow 200 further includes the order being sourced with an electronic order sourcing operation 206, with electronic operations that reserve inventory for the order and process the order fulfillment. For example, the electronic order sourcing operation 206 may include reserving inventory, considering consolidation of packages or deliveries, assigning shipping nodes, and streamlining order processing.

The workflow 200 further includes the release of the order with an electronic order release operation 208. The releasing of the order may be accompanied by a generation of a shipping tracking number or other identifier for the shipment (including identifiers for multiple packages in the shipment, or separate shipments, as applicable). The workflow 200 may then operate to identify RED and YELLOW orders in response to the electronic order release operation 208. For example, the workflow may implement electronic delay identification operations 214 for an order that has been submitted, created, sourced, and released, but has missing, incomplete, or outdated tracking information for the corresponding shipments for the order.

After the release of the order, various delays in shipping may occur that prevent the timely delivery of the shipment package(s). These delays may be identified by the electronic delay identification operations 214 which operate on the information for the particular order and the shipment package(s) associated with the particular order. As shown, the workflow 200 further includes the shipment of the order with an electronic order shipment processing operation 210, which may result in an “order shipped” notification and a collection of appropriate payment. Finally, the workflow 200 further includes fulfillment of the order with an electronic delivery processing operation 212, which operates to process data at the time that the order is delivered to the customer. The identification of RED and YELLOW delayed orders and shipments by the electronic delay identification operations 214 may operate at these times as well to perform an ongoing identification of those orders and shipments at risk—according to the evaluation of delay criterion relative to the projected (or another promised) in-hand date, as indicated above.

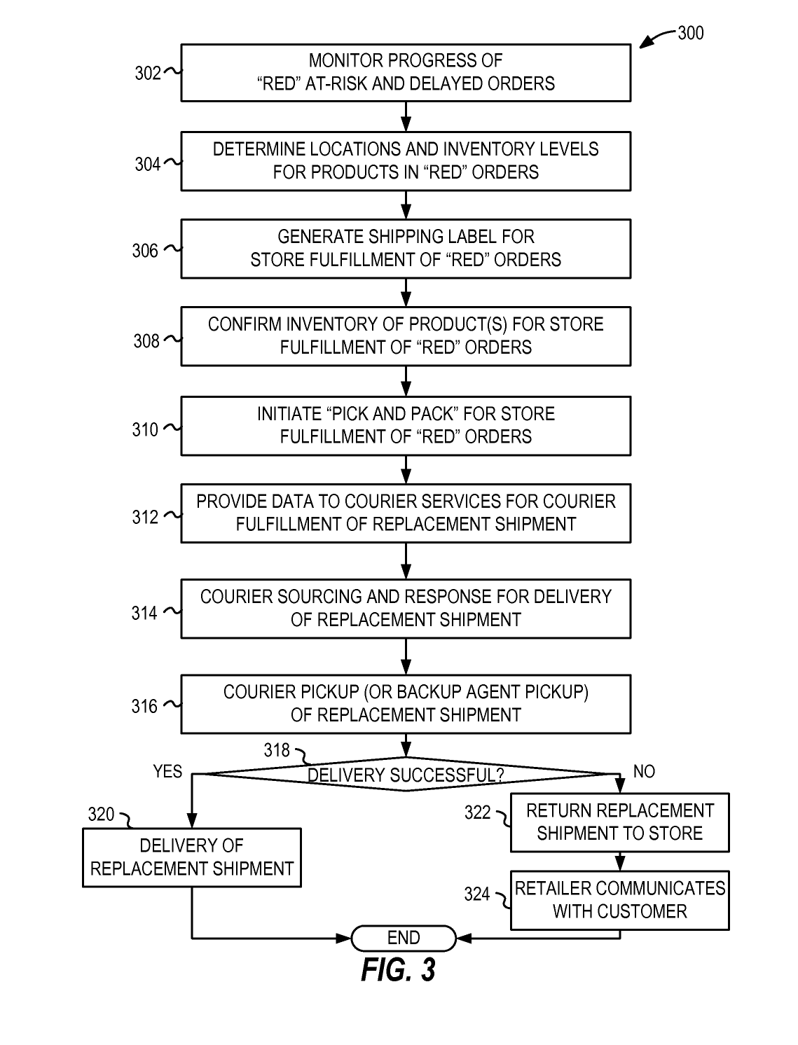

FIG. 3 illustrates an example processing flowchart 300 of a delayed order replacement workflow, as a further example of the procedures of the electronic delay identification operations 214 and related electronic processing. As shown, the processing flowchart 300 includes operations that may occur (or may be identified) within an electronic system for the identification and fulfillment of RED delayed orders and shipments. It will be understood that the techniques described, however, may be assisted by human intervention and commands from external electronic systems.

As shown, the processing flowchart 300 includes operations that are performed to initiate and fulfill a replacement shipment, with operations including identifying and monitoring the progress of RED status at-risk and delayed orders (and corresponding shipments for such orders) (operation 302). Although not fully illustrated in flowchart 300, the identification of RED and YELLOW status orders may be performed based on a current estimate of delivery dates relative to promised or projected delivery dates and times, holidays, events, or related delivery windows.

The processing flowchart 300 further includes inventory information steps for preparation of a substitute shipment for delayed orders, including determining location and inventory levels for products included in a RED status order (operation 304); and generating shipping labels for in-store fulfillment of substitute shipments, for products included in a RED status order (operation 306). Based on these inventory information steps, the product(s) to be used in a substitute shipment can be identified from an appropriate location, such as an in-store location close to the consumer.

The processing flowchart 300 further includes inventory fulfillment steps for preparation of the substitute shipment for delayed orders, including confirming inventory of the particular product for store fulfillment of the RED status order (operation 308), and in-store operations such as to “pick and pack” to fulfill the RED status order (operation 310). For example, the in-store operations may include electronic processes to identify a particular product from store inventory or displays, instruct an agent or employee with processing instructions, and prepare electronic order information to substitute the existing delayed order with a replacement from the in-store fulfillment.

The processing flowchart 300 further includes courier fulfillment steps to facilitate delivery of the substitute shipment by a courier. These steps are illustrated as including providing data to one or more courier services for courier acceptance, pickup, and fulfillment of the substitute shipment (operation 312); processing courier sourcing and responses to accept delivery of the substitute shipment (operation 314); and finally processing confirmation of the courier service pickup of the substitute shipment (operation 316). If delivery of the substitute shipment is successful (decision 318), the delivery of the substitute shipment is completed (operation 320) and may be accompanied by data processing operations to update the delivery status of the order and shipment. In other examples, if the courier service is unable to confirm pickup of the replacement shipment, a backup agent such as an employee or contractor may be designated to perform the in-store pickup and consumer delivery operations. If delivery of the substitute shipment is not successful (decision 318), then the courier service may proceed with returning the substitute shipment to the store or originating location (operation 322). The retailer then may communicate with the customer (operation 324) to offer alternative options for delivery, order fulfillment, or refund.

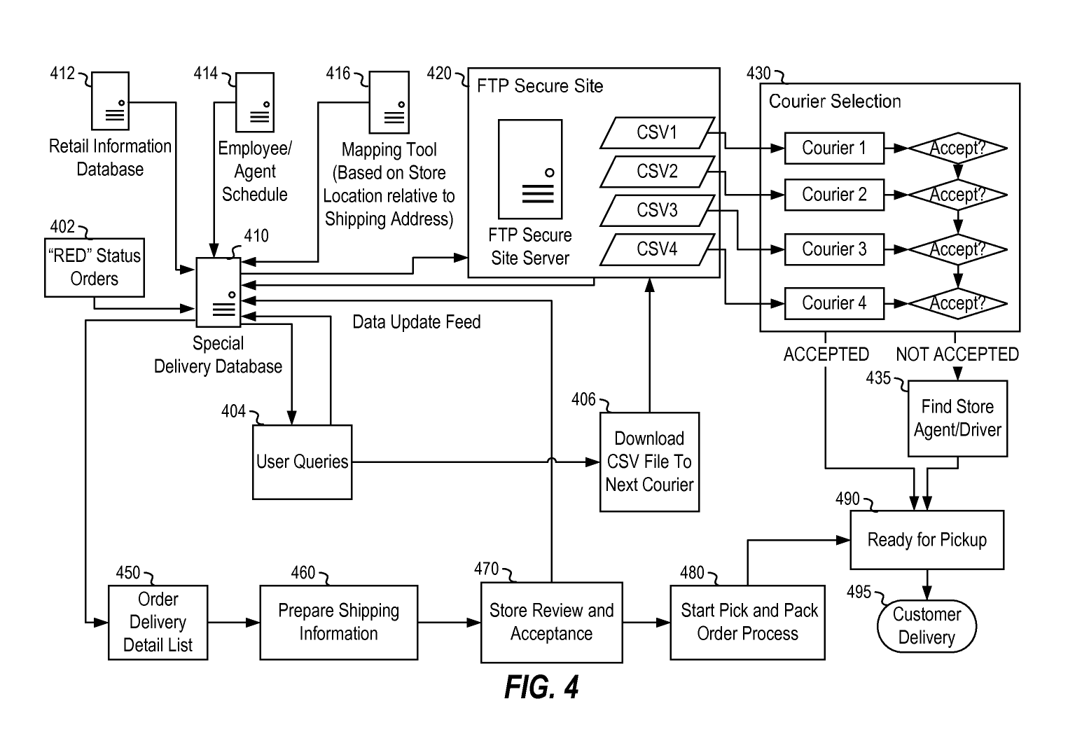

FIG. 4 illustrates an example data flow diagram for a delayed order replacement workflow according to an example described herein. As shown, the data flow diagram in FIG. 4 illustrates data operations occurring among one or more electronic systems, which operate to act upon the identification and fulfillment of RED status delayed orders and shipments. As will be understood, the identification and fulfillment of the RED status delayed orders and shipments may be facilitated by use of the electronic delay identification operations 214 or with the workflow illustrated in the flowchart 300 of FIG. 3.

In FIG. 4, data for the RED status orders 402 is provided to a special delivery database 410 for processing and tracking alternate fulfillment operations. The other information provided to the special delivery database 410 to facilitate delivery and fulfillment may include: retail data from a retail information database 412; employee/agent schedule data from an employee/agent scheduling system 414; and mapping data from a mapping tool 416. For example, the mapping tool 416 may be used to obtain a store location relative to the shipping address, and locate source locations in proximity to the customer shipping address (based on proximity and available inventory). Based on this data, user queries 404 for RED status orders, and related product fulfillment information, may be performed.

As a result of the user queries 404 with the information in the special delivery database 410, various operations may occur to enable fulfillment of the order with a substitute shipment from a particular location. This may include the creation of an order delivery detail list 450, and the preparation of shipping information 460 for the substitute shipment. A particular location (such as a brick-and-mortar store) from one or more available locations may choose to review and accept this order, with a store review and acceptance process 470. As a result of acceptance, data updates are provided to the information maintained for the substitute shipment in the special delivery database 410.

After the store review and acceptance process 470, the particular accepting store will prepare the substitute shipment for pickup, through a pick and pack order processing process 480. At the conclusion of the pick and pack order processing process 480, the replacement order enters a ready for pickup 490 process. Meanwhile, information for fulfillment of the delivery is accomplished, after the store review and acceptance process 470 (where a particular store has accepted fulfillment of the replacement order). This may be performed through the provision of delivery information from the special delivery database 410 to a delivery sourcing service, such as an FTP secure site 420 operating to serve data (in a comma-delimited CSV format, for example) to respective carriers. User queries 404 or automated queries may operate to transmit this information to the delivery sourcing service upon store review and acceptance of an order, for example.

Information may be provided from the delivery sourcing service to respective couriers via the FTP secure site 420. The information to the respective couriers may be delivered in connection with a courier selection process 430, such as the courier selection process among Couriers 1, 2, 3, and 4. The courier selection process 430 operates to provide an inquiry to another carrier if a particular carrier does not accept the replacement shipment, or if shipping terms for the replacement shipment (such as cost or timing) will not properly fulfill the order. It will be understood that fewer or additional carriers may be involved with the courier selection process, and that additional conditions for carrier delivery may be imposed.

If one of the carriers accepts the shipment request, then the courier will proceed to the store location to obtain the substitute shipment that will be indicated as ready for pickup 490. The courier then performs the customer delivery 495 to the consumer's premises (e.g., home or business). If none of the couriers accept the shipment request, then an alternate delivery mechanism may be employed. For example, the retailer may locate and enlist use of a store agent or driver 435, to directly handle the substitute shipment that will be indicated as ready for pickup 490. Accordingly, the store agent or driver may be used to perform the customer delivery 495 and fulfill the delivery for the substitute shipment.

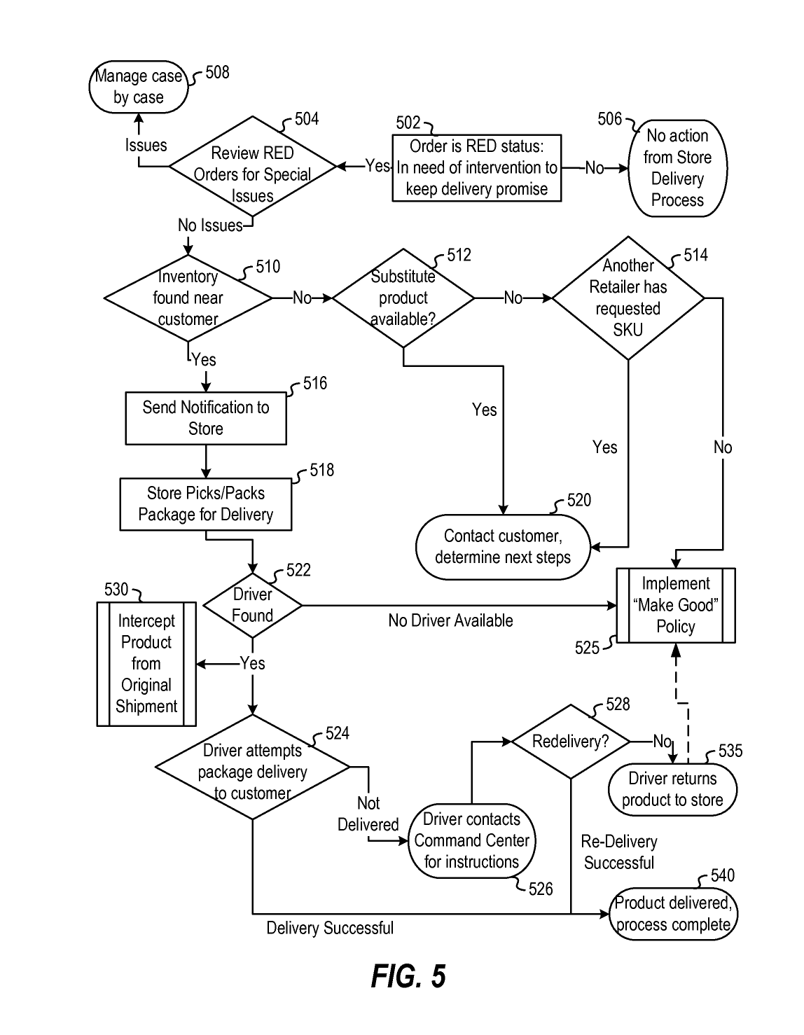

FIG. 5 illustrates an example scenario of retailer processing for a delayed order replacement workflow according to an example described herein. As will be understood, the operations and decisions in the flowchart of FIG. 5 can serve as further implementations of the data flow diagram and operations described in connection with FIGS. 3 and 4, with certain example operations being complimentary to the retailer and courier operations.

In the flowchart of FIG. 5, the electronic identification of a RED status order (or its associated delayed shipment(s)) is processed (operation 502) to determine whether the order and its associated shipment(s) are in need of intervention to meet a delivery promise, or to meet customer expectations. If intervention is not necessary, then no special processing action from the store delivery process needs to occur (result 506). If intervention is necessary, then the information associated with the order is analyzed to determine if any special issues or conditions apply (decision 504). If special issues or conditions apply, the order can be escalated to a case-by-case management center (result 508). If no special issues or conditions apply, then further processing is performed to locate a substitute product from in-store inventory and perform delivery of the substitute product in a substitute shipment.

This further processing may include electronically determining whether inventory is located near the final shipping destination of the consumer (decision 510), such as in a store or distribution center located in or near the zip code of the consumer. If inventory is not located at stores or locations near the consumer, then a further determination is made whether a substitute product is available (decision 512). If a substitute product is available, then an electronic contact is initiated to the consumer (result 520) to determine whether the substitute product is acceptable to the customer. If no substitute product is available, then an electronic evaluation is made to determine whether another retailer or source offers sales of the same product (decision 514). If the product is available at another retailer or source, then an electronic contact is initiated to the consumer (result 520) to determine whether a substitute delivery from another retailer is acceptable to the customer. If the product is not available at another retailer or source, then a “Make Good” policy, further discussed below, may be electronically implemented (process 525). (In some examples, the retailer will perform further processing to ensure that the substitute delivery is delivered to the customer; in other examples, the “Make Good” policy will be used to offer a refund or compensation the delay of the original order).

If inventory is located at one or more stores or locations near the consumer (decision 510), then further processing is performed at a store or another order fulfillment location that accepts the replacement order. This processing includes the receipt of an electronic notification (operation 516) including the replacement order details. The store or other fulfillment location will then proceed with electronically processing the replacement order information, to enable the operations of identifying, packing, picking, and preparing a package of the substitute shipment for delivery (operation 518).

The identification of an available delivery source for the substitute shipment is then made (decision 522), by locating an available courier or agent, which may include an in-store employee or delivery agent if applicable. If no courier or other driver is available to deliver the substitute shipment, then the “Make Good” policy, further discussed below, is electronically implemented (process 525). If a courier or other driver is available to deliver the substitute shipment, then substitute delivery processing is performed, and the original shipment is intercepted (process 530). The interception of the original shipment may be performed to attribute the sale to the new location (e.g., to provide credit to the store which fulfilled the replacement order).

The substitute delivery processing can be performed to determine whether the consumer successfully receives the package from the local courier or agent. First, an evaluation of the courier or agent's delivery attempt is performed (decision 524), with an evaluation of whether the delivery attempt is successful. If the initial delivery attempt is successful, the product has been delivered, and the substitute delivery process is complete (result 540). If the initial delivery attempt is not successful, the local courier or agent can contact the store or a command center (result 526) to obtain redelivery instructions. If redelivery is attempted and successful (decision 528) the process will complete (result 540); if redelivery is not successful (decision 528), then the courier or agent may return the product to the store (result 535) or other location, and the Make Good policy is electronically implemented (process 525). Other variations of delivery options and customer contact may also be used for replacement order delivery and redelivery attempts.

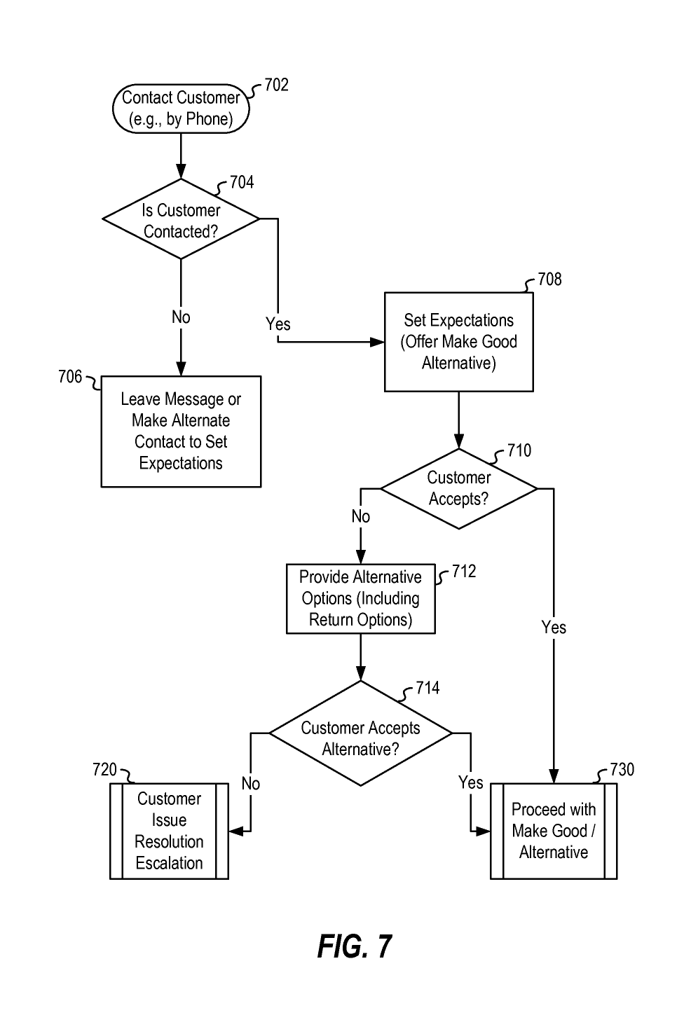

The implementation of the “Make Good” policy (process 525), referenced above, may be performed to provide compensation or other solutions for the customer to address the lack of on-time fulfillment. The use of the Make Good policy, in other words, is intended to ensure customer satisfaction despite the delayed shipment (and to compensate for any failure to successfully re-deliver a substitute shipment on time). For example, the customer compensation may be in the form of a discount, coupon, credit, gift card, or other incentive to maintain goodwill with the consumer. Further examples of implementation for the “Make Good” policy, and alternatives for the Make Good policy, are detailed below in connection with the resolution processing techniques described throughout the present disclosure, including the resolution contact workflow depicted in FIG. 7.

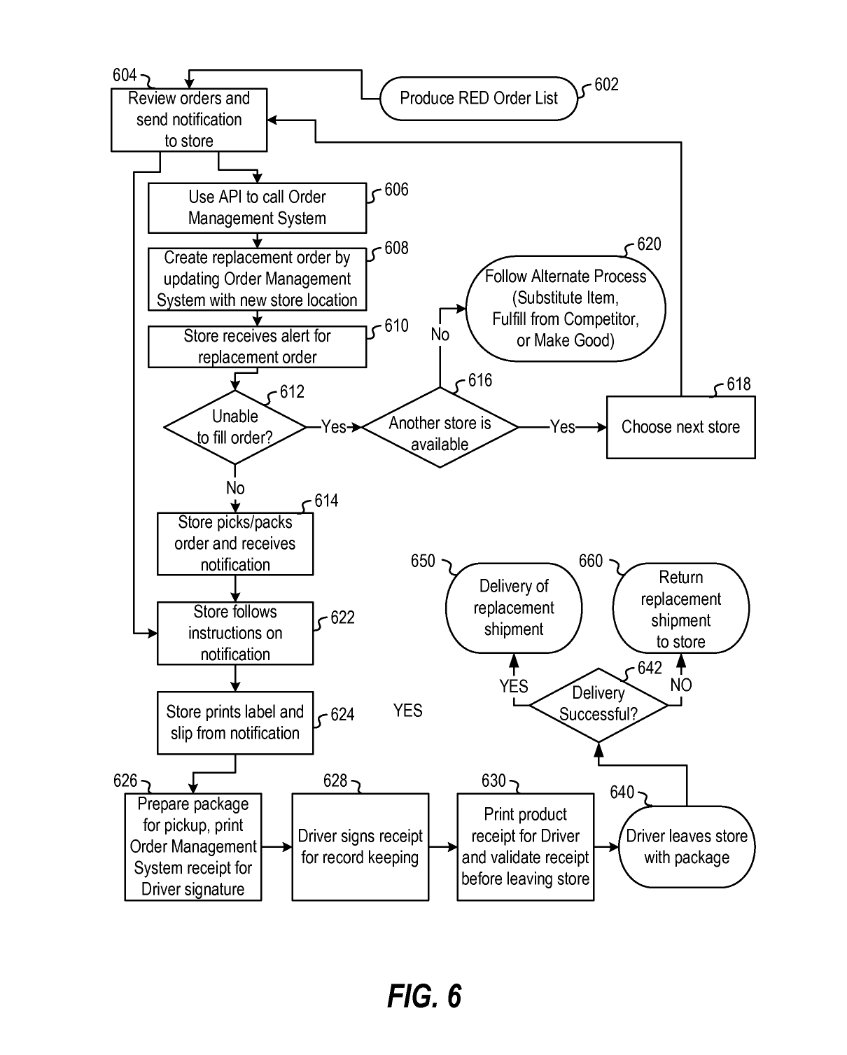

FIG. 6 illustrates an example scenario of system actions to perform delivery processing for a delayed order delivery workflow, such as may be performed systematically or with automated or human-assisted machines. For example, the system actions may be performed by an information system of a retailer in order to identify inventory and initiate a replacement order and substitute shipments in connection with the techniques described herein. As shown, the workflow may be data-driven on the basis of the identification of RED status orders (operation 602). It will be understood that similar techniques may be applied to YELLOW status orders and other order statuses.

As shown, in response to the identification of the data for the RED status orders, the retailer may review orders, and send a notification to a particular store to initiate a replacement order for store fulfillment (operation 604). The notification may include various data and information to enable the store to identify, accept, and process the replacement information for the order.

As shown, the information may be provided to an order management system of the retailer (operation 606), such as through an application programming interface (API) call to perform data inquiries and management of the order. A replacement order may be created by updating the order management system with a new store location for fulfillment of the original order (operation 608). Typically this location is selected on the basis of available inventory and proximity to the customer, although other considerations such as cost, timing, or logistics may be factored.

Upon selection of the new store location, the new store is notified with the details of the replacement order (operation 610), which may occur with an electronic alert or message. If the store is able to fulfill the order, then the store can proceed to pick and pack the order from its inventory, and receive a notification of further information for delivery (operation 614). The store may then further follow the instructions in the order notification (operation 622) and proceed with printing a shipping label and shipping slip, originating from the order information and notification (operation 624).

Final steps occurring at the store location may include preparation of the package for pickup (operation 626), which may include the use of receipt information from an order management system. The driver or other delivery agent may then confirm the information, and sign the receipt for record keeping (operation 628). The product receipt may be produced for the driver and validated before the driver leaves the store (operation 630). Finally, upon completion of these or other internal processes, the driver may leave the store with the package (result 640) and proceed to attempt delivery at the consumer location. If the delivery is successful (decision 642), then delivery of the replacement shipment can be determined as complete (result 650). If the delivery is not successful (decision 642), then delivery of the replacement shipment can be determined as incomplete, and the replacement shipment may be returned to the store (result 660), queued for redelivery, redirected to another location, or the like.

If the store is not able to fulfill the order, then the process can proceed to the determination of whether another store is available for fulfillment (decision 616), and the choice of another store (operation 618) for the repeat placement of an order as indicated in operations 604, 606, 608, 610, and 614. If no other store with the correct inventory can be located, then alternate processes may be followed (result 620). These may include offering a substitute for the item, fulfillment of the item from another retailer, distributor, or competitor, or following a Make Good process. In some examples, Make Good offers may be provided after failure of the substitute shipment. Such offers may involve the generation of Make Good savings codes and offers (e.g., through the generation of coupons, gift cards, or other compensation); electronic contact to customers with “mass action” processes; and updates data records with outcomes from the customer contacts, as performed with the data updates to Make Good orders.

In further examples, a Make Good process may be implemented in connection with automated or computer-assisted systems, business units, or like automated or human-assisted units. For example, an order triage and processing area may perform data operations for facilitating a Make Good process, including: obtaining data from orders, updating data records of orders and establishing records to offer Make Good offers as applicable to respective customers. Further, the order triage and processing area may resolve issues and prepare reports for delayed orders and related customer issues, and generate daily records for Make Good orders and order satisfactions. An enterprise customer care area may also be used for facilitating the Make Good process, including by performing data operations of: distributing or assigning Make Good orders to automated or human agents; assisting agents with contact to individual consumers; and updating data records with outcomes from the contacts, as performed with the data updates to Make Good orders. As a result of the agent assistance for contact to individual consumers, assistance may be offered to escalate to executive (e g, manager, supervisor, or other human-aided) resolution as needed.

FIG. 7 illustrates an example scenario of resolution contact procedures for a delayed order delivery workflow, such as to initiate direct contact in connection with a Make Good policy. For example, as is shown, a customer may be electronically contacted (operation 702) such as through a phone call, chat session, electronic message, or the like. If the customer is successfully contacted (decision 704), various expectations for the delayed delivery can be established, and the Make Good alternative may be offered (operation 708). If the customer is not successfully contacted (decision 704), then a message may be left or sent for the customer, or alternate arrangements or contacts may be made to inform the consumer of the scenario and to set expectations for delay resolution (operation 706).

As a result of the customer contact and offer of the Make Good alternative (operation 708), various operations may occur if the customer accepts the Make Good alternative (decision 710). If the customer accepts, the retailer may proceed with implementing the Make Good option (result 730), such as providing compensation for the delay. If the customer fails to accept the Make Good option, the system may offer various alternative options (operation 712), such as shipment return options to cancel the order. If the customer accepts the one or more alternative options (decision 714), the retailer may proceed with the alternative option (result 730) which may include interception of the in-transit shipment. If the customer rejects the one or more alternative options, the issue may be escalated to a customer issue resolution area (result 720).

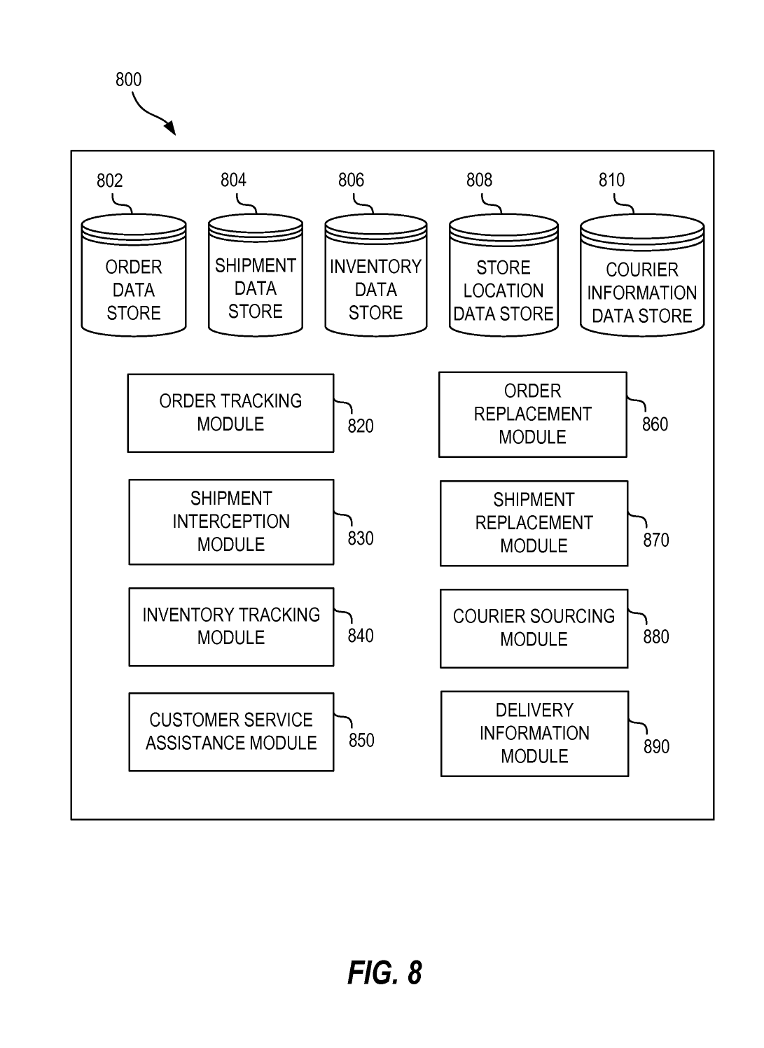

FIG. 8 illustrates a block diagram of a computing system 800 with electronic, hardware-based components according to a further example. The computing system 800 may include a processor, memory, operating system, and user input interface to interact, control, or operate the following data stores, hardware-implemented modules, network and associated devices, systems, and implementations. Specifically, the computing system 800 may be implemented within one or a plurality of computer system devices, at one or multiple locations, and may be implemented in connection with features of distributed, remote, or cloud-based processing functions.

The computing system 800 is configured to implement a plurality of modules or components for processing and fulfillment of delayed orders and shipments according to the functionality described above. The computing system 800 is also configured to implement and maintain a plurality of data stores for storing data used to provide the processing and fulfillment functionality described above. A description of the following modules and data sources follows, but it will be understood that functionality and operation of the various data sources and modules may be consolidated into fewer or expanded into additional data sources or modules.

The computing system 800 is depicted as including: an order data store 802 for storing and maintaining information related to respective orders by a consumer of various deliverable products; a shipment data store 804 for storing and maintaining information related to characteristics, tracking information, and statuses of respective shipments used to fulfill the respective orders to the consumer; an inventory data store 806 for storing and maintaining information for product availability, including information for replacement inventory to fulfill the order with a substitute shipment; a store location data store 808 for maintaining location-based information for store or inventory facilities, proximate to the original shipment location, that are capable to originate the substitute shipment; and a courier information data store 810 for storing and maintaining information related to courier delivery services, including information for courier services to perform the substitute shipment and intercept the original shipment. Additional data stores may also be used to track, persist, maintain, and update data involved in the delivery and order fulfillment functions described herein.

The computing system 800 is also depicted as including a series of modules or components providing functionality for implementing the features of a client system for interaction with a tracking system. The modules or components depicted include: an order tracking module 820 configured to perform operations that identify a delayed order, the delayed order relating to a original shipment of a particular product that remains undelivered to a destination; a shipment interception module 830 configured to perform operations that identify inventory at a particular in-store location, to fulfill delivery of the particular product in a replacement shipment to the destination; an inventory tracking module 840 configured to perform operations to facilitate an interception of the original shipment, such as to change a destination of the original shipment from the destination to a secondary destination; a customer service assistance module 850 configured to perform operations that assist management oversight of delayed orders and the generation of Make Good offers in the event of shipping delays and product unavailability; an order replacement module 860 configured to perform operations that substitute or otherwise replace the original shipment with the replacement shipment within an order management system; a shipment replacement module 870 configured to perform operations that identify one or more shipment options for a substitute delivery of the particular product in a replacement shipment; a courier sourcing module 880 configured to perform operations that provide data for a delivery substitution of the particular product to one or more couriers, and designate a particular courier for delivery of the replacement shipment; and a delivery information module 890 configured to perform operations that track the delivery of the replacement shipment to the destination and coordinate interception and order tracking activities based on the status of the replacement shipment.

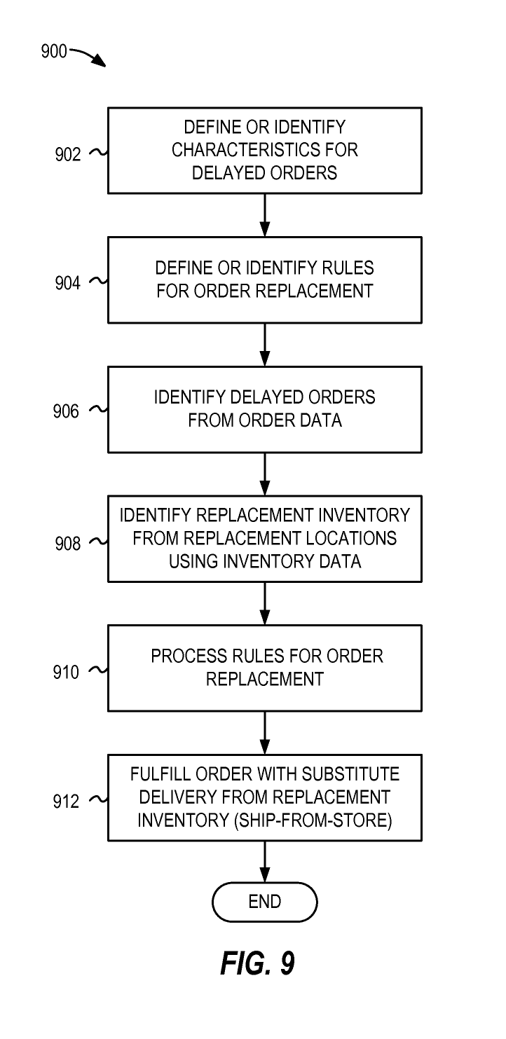

FIG. 9 illustrates an example method 900 performed by an electronic processing system for processing data with implementation of a delayed order replacement workflow. The method 900 may be implemented in hardware or software within one or more electronic devices; and in some examples, the operations of method 900 may be split across multiple entities. For example, the method 900 may be embodied by a non-transitory machine-readable medium including instructions, or one or more data processing, communication, tracking, and delivery coordination components implemented in connection with a hardware processor and a memory. Accordingly, it will be understood that the method 900 may be implemented with a computerized or electronic process that involves minimal or no human interaction.

As illustrated, the method 900 for processing data in a delayed order replacement workflow includes operations to define or identify characteristics for delayed orders (operation 902), and to define or identify rules for replacement of the delayed orders (operation 904). With the definition and identification of these characteristics and rules, various delayed orders can be identified in order data (operation 906), such as being identified in order data of a retailer's order management system. For example, automated processes may perform monitoring of in-process orders and shipments for RED and YELLOW statuses based on the characteristics and rules associated with RED and YELLOW statuses.

In response to the identification of the delayed orders, replacement orders can be sourced and fulfilled. The processes for fulfilling the delayed orders may include the identification of replacement inventory from other geographical locations (e.g., from various stores) (operation 908), using store and distribution inventory data. The replacement of the order will be implemented according to processed rules and related conditions defined for the particular status and conditions of the order (operation 910). Based on these rules, and the location of replacement inventory, a replacement order may be initiated (or the original order itself may be changed) to be fulfilled with a substitute delivery from the replacement inventory (operation 912). As previously described, such techniques may include the use of same-day ship-from-store techniques to fulfill delayed in-transit orders.

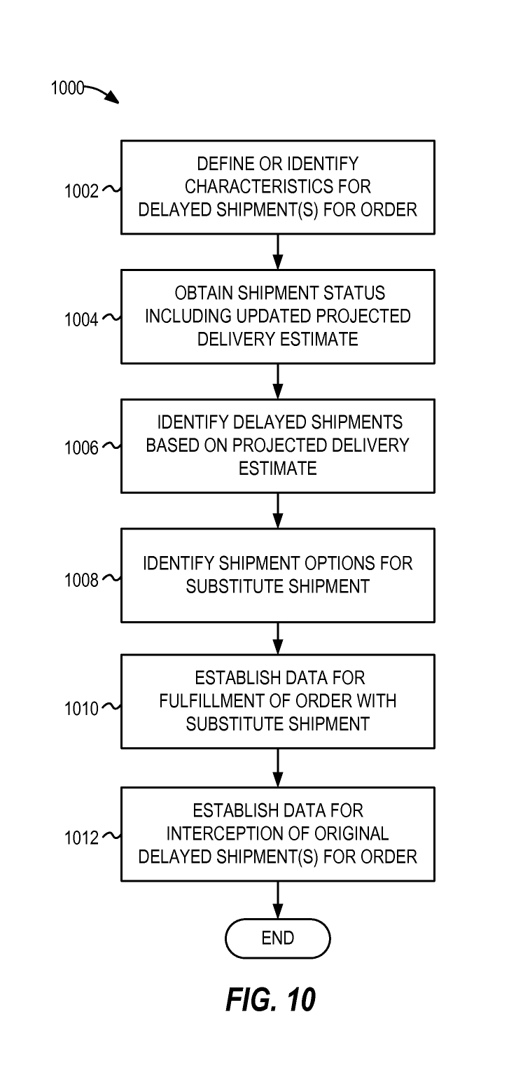

FIG. 10 illustrates an example method 1000 performed by an electronic processing system for generating shipment interception and substitution data transactions in a delayed order replacement workflow according to a further example. The method 1000 may be implemented in hardware or software within one or more electronic devices (and as steps in substitute or addition to those of FIG. 9); and in some examples the operations of method 1000 may be split across multiple entities. The method 1000 may be embodied by a non-transitory machine-readable medium including instructions, or one or more data processing, communication, tracking, and delivery coordination components implemented in connection with a hardware processor and a memory. Accordingly, it will be understood that the method 1000 may be implemented with a computerized or electronic process that involves minimal or no human interaction.

As illustrated, the method 1000 for generating shipment interception and substitution data transactions includes operations to define or identify characteristics of the one or more delayed shipments that are associated with an order (operation 1002). The definition of the characteristics for delayed shipments may occur in connection with the workflow of method 900, the use of RED or YELLOW statuses, or other applicable data-driven definitions and techniques such as those described above.

The method 1000 further operates to obtain shipment status for the various shipments of an order, including an updated projected delivery time and date estimate (operation 1004). This shipment status may occur based on data obtained from third parties (such as national shipment carriers) or based on internally tracked information. The projected delivery time and date estimate is compared to an originally projected delivery estimate, or other benchmark, to identify delayed shipments (operation 1006).

The method 1000 further operates to identify shipment options for a substitute shipment (operation 1008). These shipment options may be automatically selected or offered for selection to a human such as a customer service agent or manager. Based on the selection and choice of the shipment operations, the substitute shipment will be initiated. This is accompanied by the creation, update, or establishment of data for order fulfillment via a substitute shipment (operation 1010), and the creation, update, or establishment of data for interception of the delayed in-transit shipments from the original order (operation 1012). Further data operations may be performed to validate delivery of the substitute shipment, and the redirection of the original order shipments to a location for re-stocking.

Although the previous examples were provided with reference to substitute shipments and new delivery attempts of such substitute shipments, other variations may be provided to RED and YELLOW status orders to increase the chances of delivery. For example, changes to delivery speed (e.g., from standard ground to 2-day or next-day shipping) of existing in-transit shipments may be implemented into these procedures, to attempt resolution without needing a substitute shipment. In a similar fashion, customer contact and options may be presented at an earlier point of the identification of the delivery delay, including offering options for compensation in exchange for the delayed delivery. It will be apparent that other variations to delivery scheduling, substitution, and interception may be performed in connection with these and other workflows provided with the presently described techniques.

Embodiments used to facilitate and perform the techniques described herein may be implemented in one or a combination of hardware, firmware, and software. Embodiments may also be implemented as instructions stored on a machine-readable storage medium (e.g., a storage device), which may be read and executed by at least one processor to perform the operations described herein. A machine-readable storage medium may include any non-transitory mechanism for storing information in a form readable by a machine (e.g., a computer). For example, a machine-readable storage device may include read-only memory (ROM), random-access memory (RAM), magnetic disk storage media, optical storage media, flash-memory devices, and other storage devices and media.

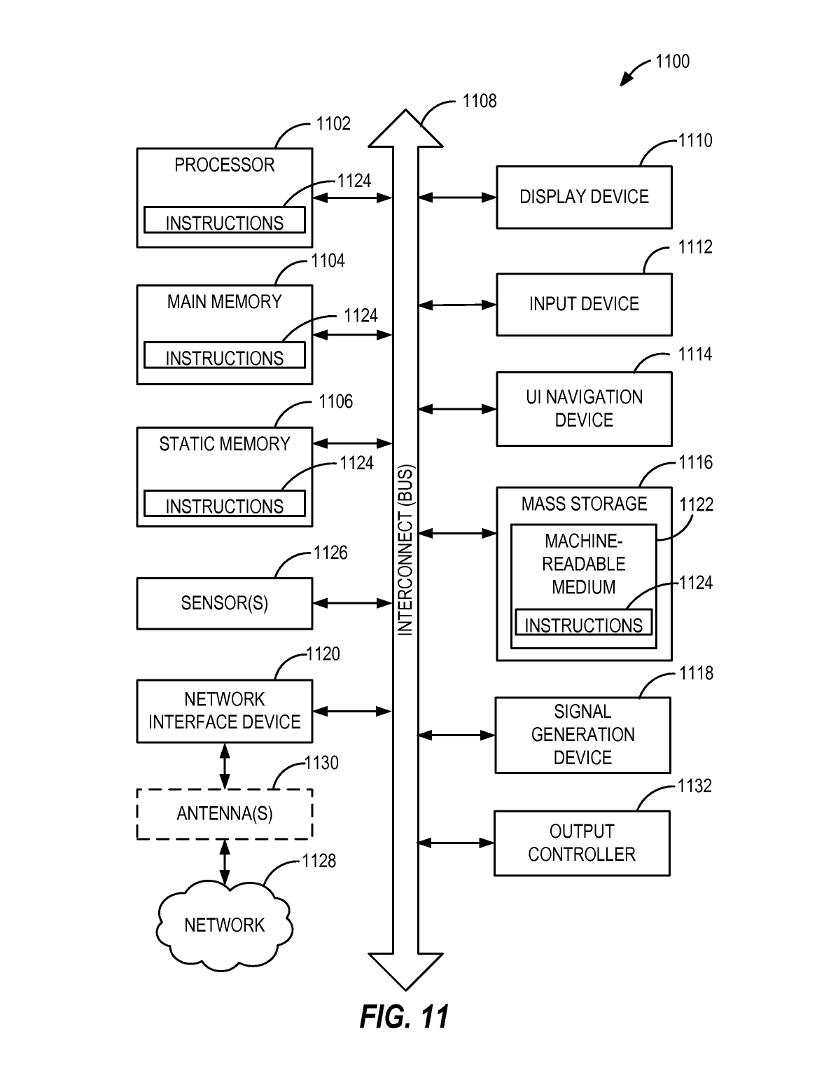

FIG. 11 illustrates a block diagram illustrating a machine in the example form of a computer system 1100, within which a set or sequence of instructions may be executed to cause the machine to perform any one of the methodologies discussed herein, according to an example. Computer system machine 1100 may be embodied by the electronic processing system 800; the subsystem(s) implementing the data stores 802, 804, 806, 808, 810; the subsystem(s) implementing the various modules or components 820, 830, 840, 850, 860, 870, 880, 890; the data terminal 108; the computer system for processing operations 202, 204, 206, 208, 210, 212; the data processing elements 410, 412, 414, 416, 420; or any other electronic processing or computing platform described or referred to herein.

Example computer system 1100 includes at least one processor 1102 (e.g., a central processing unit (CPU), a graphics processing unit (GPU) or both, processor cores, compute nodes, etc.), a main memory 1104 and a static memory 1106, which communicate with each other via an interconnect 1108 (e.g., a link, a bus, etc.). The computer system 1100 may further include a video display unit 1110, an alphanumeric input device 1112 (e.g., a keyboard), and a user interface (UI) navigation device 1114 (e.g., a mouse). In one example, the video display unit 1110, input device 1112 and UI navigation device 1114 are incorporated into a touchscreen interface and touchscreen display. The computer system 1100 may additionally include a storage device 1116 (e.g., a drive unit), a signal generation device 1118 (e.g., a speaker), an output controller 1132, a network interface device 1120 (which may include or operably communicate with one or more antennas 1130, transceivers, or other wireless communications hardware), and one or more sensors 1126, such as a global positioning system (GPS) sensor, compass, accelerometer, location sensor, or other sensor.

The storage device 1116 includes a machine-readable medium 1122 on which is stored one or more sets of data structures and instructions 1124 (e.g., software) embodying or utilized by any one or more of the methodologies or functions described herein. The instructions 1124 may also reside, completely or at least partially, within the main memory 1104, static memory 1106, and/or within the processor 1102 during execution thereof by the computer system 1100, with the main memory 1104, static memory 1106, and the processor 1102 also constituting machine-readable media.

While the machine-readable medium 1122 is illustrated in an example to be a single medium, the term “machine-readable medium” may include a single medium or multiple media (e.g., a centralized or distributed database, and/or associated caches and servers) that store the one or more instructions 1124. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The instructions 1124 may further be transmitted or received over a communications network 1128 using a transmission medium via the network interface device 1120 utilizing any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., Wi-Fi, 2G/3G, and 4G LTE/LTE-A or WiMAX networks). The term “transmission medium” shall be taken to include any intangible medium that is capable of storing, encoding, or carrying instructions for execution by the machine, and includes digital or analog communications signals or other intangible medium to facilitate communication of such software.

Additional examples of the presently described method, system, and device embodiments include the following, non-limiting configurations. Each of the following non-limiting examples may stand on its own, or may be combined in any permutation or combination with any one or more of the other examples provided below or throughout the present disclosure.

Example 1 includes subject matter (such as a method, means for performing acts, machine readable medium including instructions that when performed by a machine cause the machine to performs acts, or an apparatus to perform) comprising: electronically identifying a delayed order, the delayed order relating to a shipment of a particular product that is undelivered to a destination, wherein the delayed order is delayed relative to an original delivery estimation for delivery of the shipment of the particular product to the destination; electronically identifying inventory at a particular in-store location, the inventory to fulfill delivery of the particular product in a replacement shipment to the destination, wherein the inventory in the particular in-store location is located from a plurality of in-store locations based on proximity of the particular in-store location to the destination; creating data that identifies at least one shipment option for a substitute delivery of the particular product in the replacement shipment, the substitute delivery of the particular product occurring from the identified inventory at the particular in-store location to the destination, wherein the replacement shipment is identified to meet the original delivery estimation for delivery of the shipment of the particular product to the destination; and creating data that facilitates performance of the substitute delivery of the particular product in the replacement shipment, the substitute delivery of the replacement shipment to the destination being performed via a selected shipment option of the identified at least one shipment option.

In Example 2, the subject matter of Example 1 may include, creating data that facilitates an interception of the shipment that is undelivered, wherein the shipment that is undelivered is in transit, and wherein the destination of the shipment that is undelivered is changed from a first address to a second address.

In Example 3, the subject matter of any one of Examples 1 to 2 may include, wherein the first address is a designated shipping address of a consumer, and wherein the second address is an address of one of: a distribution center, an origin location of the shipment, the in-store location of the replacement shipment, or an alternate in-store location.

In Example 4, the subject matter of any one of Examples 1 to 3 may include, wherein electronically identifying inventory at the particular in-store location to fulfill delivery of the particular product includes: locating the particular product at an in-store location, the in-store location being one of a plurality of store locations that has inventory for the particular product and that is located closest to the destination.

In Example 5, the subject matter of any one of Examples 1 to 4 may include, wherein electronically identifying the delayed order includes: identifying a promised delivery date for the shipment of the particular product to the destination, wherein the promised delivery date is communicated to an originating consumer of the delayed order; and identifying that the shipment of the particular product is unable to be delivered to the destination by the promised delivery date via one or more available shipping options from a carrier of the shipment.

In Example 6, the subject matter of any one of Examples 1 to 5 may include, wherein the promised delivery date for the shipment of the particular product to the destination is prior to a designated holiday, and wherein the replacement shipment is identified to meet the original delivery estimation by an estimated arrival prior to the designated holiday.

In Example 7, the subject matter of any one of Examples 1 to 6 may include, wherein creating data that identifies the at least one shipment option for the substitute delivery of the particular product in the replacement shipment includes providing data to a plurality of couriers.

In Example 8, the subject matter of any one of Examples 1 to 7 may include, wherein creating data that identifies the at least one shipment option for the substitute delivery of the particular product in the replacement shipment includes: receiving an indication from a particular courier of the plurality of couriers to accept delivery of the replacement shipment to the destination; and designating the particular courier for delivery of the replacement shipment to the destination, in response to receiving the indication from the particular courier to accept delivery of the replacement shipment to the destination.

In Example 9, the subject matter of any one of Examples 1 to 8 may include, electronically tracking the delivery of the replacement shipment to the destination via the selected shipment option; electronically notifying an order management system of a successful delivery of the replacement shipment to the destination; and electronically processing data from the shipment of the particular product that is undelivered to a destination to determine an alternate destination for the shipment.

Example 10 includes subject matter of a computer-readable medium (operating on a computing device, apparatus, machine, or the like) comprising instructions that cause the computing device to: identify a delayed order, the delayed order being associated with an shipment of a particular product that is undelivered to a destination, wherein the delayed order is delayed relative to an original delivery estimation for delivery of the shipment of the particular product to the destination; identify inventory at a particular in-store location, the inventory to fulfill delivery of the particular product in a replacement shipment to the destination, wherein the inventory in the particular in-store location is located from a plurality of in-store locations based on proximity of the particular in-store location to the destination; identify at least one shipment option for a substitute delivery of the particular product in the replacement shipment, the substitute delivery of the particular product to occur from the identified inventory at the particular in-store location to the destination, wherein the replacement shipment is identified to meet the original delivery estimation for delivery of the shipment of the particular product to the destination; and initiate the substitute delivery of the particular product in the replacement shipment, the substitute delivery of the replacement shipment to the destination being performed via a selected shipment option of the identified at least one shipment option.

In Example 11, the subject matter of Example 10 may include, the instructions further causing the computing device to: facilitate an interception of the shipment that is undelivered, wherein the shipment that is undelivered is in transit, and wherein the destination of the shipment that is undelivered is changed from a first address to a second address.

In Example 12, the subject matter of any one of Examples 10 to 11 may include, wherein the first address is a designated shipping address of a consumer, and wherein the second address is an address of one of: a distribution center, an origin location of the shipment, the in-store location of the replacement shipment, or an alternate in-store location.

In Example 13, the subject matter of any one of Examples 10 to 12 may include, the instructions further causing the computing device to: identify inventory at the particular in-store location to fulfill the particular product by an identification of the particular product at an in-store location, the in-store location being one of a plurality of store locations that has inventory for the particular product and that is located closest to the destination.

In Example 14, the subject matter of any one of Examples 10 to 13 may include, the instructions further causing the computing device to: identify a promised delivery date for the shipment of the particular product to the destination, wherein the promised delivery date is communicated to an originating consumer of the delayed order; and identify that the shipment of the particular product is unable to be delivered to the destination by the promised delivery date via one or more available shipping options from a carrier of the shipment; wherein the promised delivery date for the shipment of the particular product to the destination is prior to a designated holiday, and wherein the replacement shipment is identified to meet the original delivery estimation by an estimated arrival prior to the designated holiday.

In Example 15, the subject matter of any one of Examples 10 to 14 may include, the instructions further causing the computing device to: provide data to a plurality of couriers; receive an indication from a particular courier of the plurality of couriers to accept delivery of the replacement shipment to the destination; and designate the particular courier for delivery of the replacement shipment to the destination, in response to receipt of the indication from the particular courier to accept delivery of the replacement shipment to the destination.

In Example 16, the subject matter of any one of Examples 10 to 15 may include, the instructions further causing the computing device to: track the delivery of the replacement shipment to the destination via the selected shipment option; notify an order management system of a successful delivery of the replacement shipment to the destination; and process the shipment of the particular product to determine an alternate destination for the shipment.

Example 17 includes subject matter (such as a device, apparatus, or machine) of an electronic system comprising: an order tracking module, the order tracking module configured to identify a delayed order, the delayed order relating to a shipment of a particular product that is undelivered to a destination, wherein the delayed order is delayed relative to an original delivery estimation for delivery of the shipment of the particular product to the destination; an inventory tracking module, the inventory tracking module configured to identify inventory at a particular in-store location, the inventory to fulfill delivery of the particular product in a replacement shipment to the destination, wherein the inventory in the particular in-store location is located from a plurality of in-store locations based on proximity of the particular in-store location to the destination; a shipment replacement module, the shipment replacement module configured to identify at least one shipment option for a substitute delivery of the particular product in the replacement shipment, the substitute delivery of the particular product occurring from the identified inventory at the particular in-store location to the destination, wherein the replacement shipment is identified to meet the original delivery estimation for delivery of the shipment of the particular product to the destination; and a delivery information module, the delivery information module configured to facilitate performance of the substitute delivery of the particular product in the replacement shipment, the substitute delivery of the replacement shipment to the destination being performed via a selected shipment option of the identified at least one shipment option.

In Example 18, the subject matter of Example 17 may include, the plurality of modules a shipment interception module, the shipment interception module configured to facilitate an interception of the shipment that is undelivered, wherein a destination of the shipment is changed from a first address to a second address; wherein the first address is a designated shipping address of a consumer, and wherein the second address is an address of one of: a distribution center, an origin location of the shipment, the in-store location of the replacement shipment, or an alternate in-store location.

In Example 19, the subject matter of any one of Examples 17 to 18 may include, the plurality of modules an order replacement module, the order replacement module configured to: track the delivery of the replacement shipment to the destination; and replace the shipment with the replacement shipment within an order management system, in response to initiation of the delivery of the replacement shipment to the destination.

In Example 20, the subject matter of any one of Examples 17 to 19 may include, the plurality of modules a courier sourcing module, the courier sourcing module configured to: provide data that identifies the at least one shipment option for the substitute delivery of the particular product to a plurality of couriers; receive an indication from a particular courier of the plurality of couriers to accept delivery of the replacement shipment to the destination; and designate the particular courier for delivery of the replacement shipment to the destination, in response to receiving the indication from the particular courier to accept delivery of the replacement shipment to the destination.

Additional examples of the presently described method, system, and device embodiments include the following configurations recited by the claims. Each of the examples in the claims may stand on its own, or may be combined in any permutation or combination with any one or more of the other examples provided below or throughout the present disclosure.

What is claimed is:

1. A method for processing data in a delayed order delivery fulfillment scenario, the method performed by a computer system comprising at least one hardware processor, and the method comprising:
electronically identifying a delayed order, the delayed order relating to a shipment of a particular product that is undelivered to a destination, wherein the delayed order is delayed relative to an original delivery estimation for delivery of the shipment of the particular product to the destination;
electronically identifying inventory at a particular in-store location, the inventory to fulfill delivery of the particular product in a replacement shipment to the destination, wherein the inventory in the particular in-store location is located from a plurality of in-store locations based on proximity of the particular in-store location to the destination;
creating data that identifies at least one shipment option for a substitute delivery of the particular product in the replacement shipment, the substitute delivery of the particular product occurring from the identified inventory at the particular in-store location to the destination, wherein the replacement shipment is identified to meet the original delivery estimation for delivery of the shipment of the particular product to the destination; and
creating data that facilitates performance of the substitute delivery of the particular product in the replacement shipment, the substitute delivery of the replacement shipment to the destination being performed via a selected shipment option of the identified at least one shipment option.

2. The method of claim 1, comprising:
creating data that facilitates an interception of the shipment that is undelivered, wherein the shipment that is undelivered is in transit, and wherein the destination of the shipment that is undelivered is changed from a first address to a second address.

3. The method of claim 2, wherein the first address is a designated shipping address of a consumer, and wherein the second address is an address of one of: a distribution center, an origin location of the shipment, the in-store location of the replacement shipment, or an alternate in-store location.

4. The method of claim 1, wherein electronically identifying inventory at the particular in-store location to fulfill delivery of the particular product includes:
locating the particular product at an in-store location, the in-store location being one of a plurality of store locations that has inventory for the particular product and that is located closest to the destination.

5. The method of claim 1, wherein electronically identifying the delayed order includes:
identifying a promised delivery date for the shipment of the particular product to the destination, wherein the promised delivery date is communicated to an originating consumer of the delayed order; and
identifying that the shipment of the particular product is unable to be delivered to the destination by the promised delivery date via one or more available shipping options from a carrier of the shipment.

6. The method of claim 5, wherein the promised delivery date for the shipment of the particular product to the destination is prior to a designated holiday, and wherein the replacement shipment is identified to meet the original delivery estimation by an estimated arrival prior to the designated holiday.

7. The method of claim 1, wherein creating data that identifies the at least one shipment option for the substitute delivery of the particular product in the replacement shipment includes providing data to a plurality of couriers.

8. The method of claim 7, wherein creating data that identifies the at least one shipment option for the substitute delivery of the particular product in the replacement shipment includes:
receiving an indication from a particular courier of the plurality of couriers to accept delivery of the replacement shipment to the destination; and
designating the particular courier for delivery of the replacement shipment to the destination, in response to receiving the indication from the particular courier to accept delivery of the replacement shipment to the destination.

9. The method of claim 1, comprising:
electronically tracking the delivery of the replacement shipment to the destination via the selected shipment option;
electronically notifying an order management system of a successful delivery of the replacement shipment to the destination; and
electronically processing data from the shipment of the particular product that is undelivered to a destination to determine an alternate destination for the shipment.

10. At least one non-transitory machine-readable storage medium including instructions for processing data, the storage medium comprising instructions, that when executed by a computing device, cause at least one hardware processor of the computing device to:
identify a delayed order, the delayed order being associated with an shipment of a particular product that is undelivered to a destination, wherein the delayed order is delayed relative to an original delivery estimation for delivery of the shipment of the particular product to the destination;
identify inventory at a particular in-store location, the inventory to fulfill delivery of the particular product in a replacement shipment to the destination, wherein the inventory in the particular in-store location is located from a plurality of in-store locations based on proximity of the particular in-store location to the destination;
identify at least one shipment option for a substitute delivery of the particular product in the replacement shipment, the substitute delivery of the particular product to occur from the identified inventory at the particular in-store location to the destination, wherein the replacement shipment is identified to meet the original delivery estimation for delivery of the shipment of the particular product to the destination; and
initiate the substitute delivery of the particular product in the replacement shipment, the substitute delivery of the replacement shipment to the destination being performed via a selected shipment option of the identified at least one shipment option.

11. The machine-readable storage medium of claim 10, the instructions further causing the computing device to:
facilitate an interception of the shipment that is undelivered, wherein the shipment that is undelivered is in transit, and wherein the destination of the shipment that is undelivered is changed from a first address to a second address.

12. The machine-readable storage medium of claim 11, wherein the first address is a designated shipping address of a consumer, and wherein the second address is an address of one of: a distribution center, an origin location of the shipment, the in-store location of the replacement shipment, or an alternate in-store location.

13. The machine-readable storage medium of claim 10, the instructions further causing the computing device to:
identify inventory at the particular in-store location to fulfill the particular product by an identification of the particular product at an in-store location, the in-store location being one of a plurality of store locations that has inventory for the particular product and that is located closest to the destination.

14. The machine-readable storage medium of claim 10, the instructions further causing the computing device to:
identify a promised delivery date for the shipment of the particular product to the destination, wherein the promised delivery date is communicated to an originating consumer of the delayed order; and
identify that the shipment of the particular product is unable to be delivered to the destination by the promised delivery date via one or more available shipping options from a carrier of the shipment;
wherein the promised delivery date for the shipment of the particular product to the destination is prior to a designated holiday, and wherein the replacement shipment is identified to meet the original delivery estimation by an estimated arrival prior to the designated holiday.

15. The machine-readable storage medium of claim 10, the instructions further causing the computing device to:
provide data to a plurality of couriers;
receive an indication from a particular courier of the plurality of couriers to accept delivery of the replacement shipment to the destination; and
designate the particular courier for delivery of the replacement shipment to the destination, in response to receipt of the indication from the particular courier to accept delivery of the replacement shipment to the destination.

16. The machine-readable storage medium of claim 10, the instructions further causing the computing device to:
track the delivery of the replacement shipment to the destination via the selected shipment option;
notify an order management system of a successful delivery of the replacement shipment to the destination; and
process the shipment of the particular product to determine an alternate destination for the shipment.

17. A computing system, comprising at least one hardware processor, and a plurality of modules implemented with operation of the hardware processor, the plurality of modules including:
an order tracking module, the order tracking module configured to identify a delayed order, the delayed order relating to a shipment of a particular product that is undelivered to a destination, wherein the delayed order is delayed relative to an original delivery estimation for delivery of the shipment of the particular product to the destination;
an inventory tracking module, the inventory tracking module configured to identify inventory at a particular in-store location, the inventory to fulfill delivery of the particular product in a replacement shipment to the destination, wherein the inventory in the particular in-store location is located from a plurality of in-store locations based on proximity of the particular in-store location to the destination;
a shipment replacement module, the shipment replacement module configured to identify at least one shipment option for a substitute delivery of the particular product in the replacement shipment, the substitute delivery of the particular product occurring from the identified inventory at the particular in-store location to the destination, wherein the replacement shipment is identified to meet the original delivery estimation for delivery of the shipment of the particular product to the destination; and
a delivery information module, the delivery information module configured to facilitate performance of the substitute delivery of the particular product in the replacement shipment, the substitute delivery of the replacement shipment to the destination being performed via a selected shipment option of the identified at least one shipment option.

18. The computing system of claim 17, the plurality of modules including a shipment interception module, the shipment interception module configured to facilitate an interception of the shipment that is undelivered, wherein a destination of the shipment is changed from a first address to a second address;
wherein the first address is a designated shipping address of a consumer, and wherein the second address is an address of one of: a distribution center, an origin location of the shipment, the in-store location of the replacement shipment, or an alternate in-store location.

19. The computing system of claim 17, the plurality of modules including an order replacement module, the order replacement module configured to:
track the delivery of the replacement shipment to the destination; and
replace the shipment with the replacement shipment within an order management system, in response to initiation of the delivery of the replacement shipment to the destination.

20. The computing system of claim 17, the plurality of modules including a courier sourcing module, the courier sourcing module configured to:
provide data that identifies the at least one shipment option for the substitute delivery of the particular product to a plurality of couriers;
receive an indication from a particular courier of the plurality of couriers to accept delivery of the replacement shipment to the destination; and
designate the particular courier for delivery of the replacement shipment to the destination, in response to receiving the indication from the particular courier to accept delivery of the replacement shipment to the destination.
